(19) United States
(12) Patent Application Publication
(10) Pub. No.: US 2011/0020060 A1
(43) Pub. Date: Jan. 27, 2011

(54) REVERSIBLE ATTACHMENT APPARATUS FOR A FOOTPEG ASSEMBLY

(76) Inventor: Mon Spencer Owyang, Capitola, CA (US)

Correspondence Address: James P. Broder;Roeder & Broder LLP, 9915 Mira Mesa Blvd. Suite 300, San Diego, CA, 92131, US

(21) Appl. No.: 12/508,489

(22) Filed: Jul. 23, 2009

(51) Int. Cl. F16D 1/00; B62J 25/00; B62J 27/00

(52) U.S. Cl. 403/408.1; 280/291; 280/304.3

(57) ABSTRACT

An attachment apparatus for adjusting the position of a footpeg of a motorcycle relative to a frame of the motorcycle includes a base plate and a support plate. The base plate is coupled to the frame. The support plate is secured to the base plate. The support plate includes a first side, a second side that is opposite the first side, and a footpeg retainer that retains the footpeg. The support plate alternatively supports the footpeg in a first position while the first side contacts the base plate and in a second position while the second side contacts the base plate. The second position is different relative to the frame than the first position. The support plate can include a supporter aperture and the base plate can include a base plate aperture. A plate attacher can extend through the supporter aperture and the base plate aperture to secure the support plate to the base plate. The footpeg retainer can include a footpeg retainer aperture that is adapted to receive a portion of the footpeg.

### BACKGROUND

Recreational riding and competitive racing of two-wheeled vehicles such as motorcycles has become increasingly popular in recent years. Motorcycle riders place great value on the ability to precisely control the positioning of important mechanical components on their vehicles. For instance, the positioning of a motorcycle footpeg assembly, including a footpeg and shifter can vary significantly. More specifically, because riders can be almost any height and can have any body proportions, the ability to adjust the footpeg assembly upward, downward, forward and/or rearward is critical for both comfort and machine control.

Accordingly, as the act of riding and racing a motorcycle requires a high level of attention, having footpeg assemblies which function in a fluid and natural fashion while the motorcycle is being ridden is also highly valued. Prior methods for adjusting and optimizing footpeg positioning can be overly complex, confusing, imprecise and/or time-consuming. For example, these adjustment mechanisms can be clumsy and cannot offer the required level of precision and ease required for high-performance or other types of motorcycles.

### SUMMARY

The present invention is directed toward an attachment apparatus for adjusting the position of a footpeg of a motorcycle relative to a frame of the motorcycle. In some embodiments, the attachment apparatus includes a base plate and a support plate. The base plate is coupled to the frame. The support plate is secured to the base plate. In certain embodiments, the support plate includes a first side, a second side that is opposite the first side, and a footpeg retainer that retains the footpeg. Importantly, the support plate alternatively supports the footpeg in a first position while the first side contacts the base plate and in a second position while the second side contacts the base plate. The second position is different relative to the frame than the first position.

In one embodiment, at least a portion of the first side is substantially planar. Additionally, or alternatively, at least a portion of the second side can also be substantially planar.

In some embodiments, the attachment apparatus further comprises a plate attacher that secures the support plate to the base plate. In certain embodiments, the support plate includes a supporter aperture and the base plate includes a base plate aperture. In these embodiments, the plate attacher extends through the supporter aperture and the base plate aperture to secure the support plate to the base plate. In one such embodiment, the supporter aperture includes a slot so that the support plate is slidably secured to the base plate.

In one embodiment, the base plate includes a guide stud and the support plate includes a guide aperture. In this embodiment, the guide aperture is adapted to receive the guide stud to inhibit the support plate from being improperly secured to the base plate. Additionally, the guide aperture can be positioned so that unless the guide stud is received by the guide aperture, the plate attacher will not extend through at least one of the supporter aperture and the base plate aperture.

In certain embodiments, the attachment apparatus includes a pair of plate attachers that secure the support plate to the base plate. Further, in one such embodiment, the support plate includes a plurality of pairs of supporter apertures and the base plate includes a plurality of pairs of base plate apertures. In this embodiment, the pair of plate attachers extends through one pair of supporter apertures and one pair of base plate apertures to secure the support plate to the base plate.

In some embodiments, the attachment apparatus includes two pairs of plate attachers that secure the support plate to the base plate. In one such embodiment, the support plate includes a plurality of pairs of supporter apertures and the base plate includes a plurality of pairs of base plate apertures. In this embodiment, the two pairs of plate attachers extend through two pairs of supporter apertures and two pairs of base plate apertures to secure the support plate to the base plate.

In one embodiment, the footpeg retainer includes a footpeg retainer aperture that is adapted to receive a portion of the footpeg. In another embodiment, the footpeg retainer includes a plurality of footpeg retainer apertures. In this embodiment, each footpeg retainer aperture is adapted to receive a portion of the footpeg.

Additionally, in certain embodiments, the support plate includes a longitudinal axis. In one such embodiment, the footpeg retainer is offset from the support axis.

In some embodiments, the base plate includes a base plate contact surface and the support plate includes a support plate contact surface. In such embodiments, the support plate contact surface directly contacts the base plate contact surface when the support plate is secured to the base plate. In one embodiment, the base plate contact surface and the support plate contact surface are substantially complimentary to each other.

The present invention is also directed toward a method for adjusting the position of a footpeg of a motorcycle relative to a frame of the motorcycle.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified side view of a motorcycle and one embodiment of a reversible attachment apparatus having features of the present invention;

FIG. 2A is a side view of a portion of a frame and one embodiment of the reversible attachment apparatus;

FIG. 2B is a side view of one embodiment of a base plate of the reversible attachment apparatus illustrated in FIG. 2A;

FIG. 2C is an end view of the base plate illustrated in FIG. 2B;

FIG. 2D is a side view of a first side of a support plate of the reversible attachment apparatus illustrated in FIG. 2A;

FIG. 2E is a side view of a second side of the support plate illustrated in FIG. 2D;

FIG. 2F is a cross-sectional view of the base plate and the support plate taken on line 2F-2F in FIG. 2A;

FIG. 2G is a cross-sectional view of the base plate, the support plate, and a pair of plate attachers taken on line 2G-2G in FIG. 2A;

FIG. 3 is a side view of another embodiment of a support plate of the reversible attachment apparatus;

FIG. 4 is a side view of yet another embodiment of a support plate of the reversible attachment apparatus;

FIG. 5A is a side view of a portion of a motorcycle and another embodiment of a reversible attachment apparatus having features of the present invention; and

FIG. 5B is a side view of the portion of the motorcycle and the reversible attachment apparatus in FIG. 5A, with the support plate having been reversed.

### DESCRIPTION

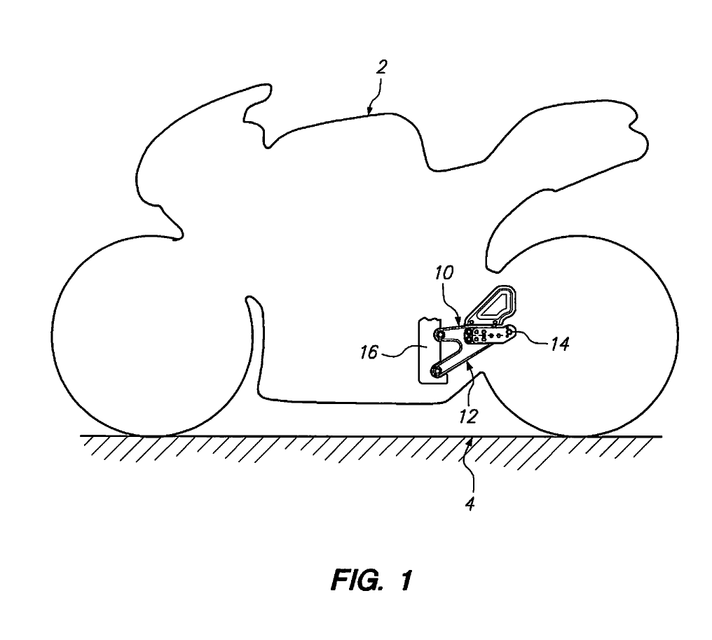

FIG. 1 shows an outline of a motorcycle 2 and a surface 4 over which the motorcycle 2 moves. The motorcycle includes and illustrates the approximate positioning of a reversible attachment apparatus 10 (sometimes referred to herein as “attachment apparatus”) and a footpeg assembly 12, including a footpeg 14. In actual use, the attachment apparatus 10 is secured to a frame 16 (only a portion of which is illustrated in FIG. 1) of the motorcycle 2 or another suitable motorized vehicle (i.e. all-terrain vehicle, etc., not shown). As background, the attachment apparatus 10 and any components that are attached to the attachment apparatus 10, which can include a footpeg, a gear shifter, a brake pedal, etc., are often collectively referred to herein and in the industry as a “rearset”.

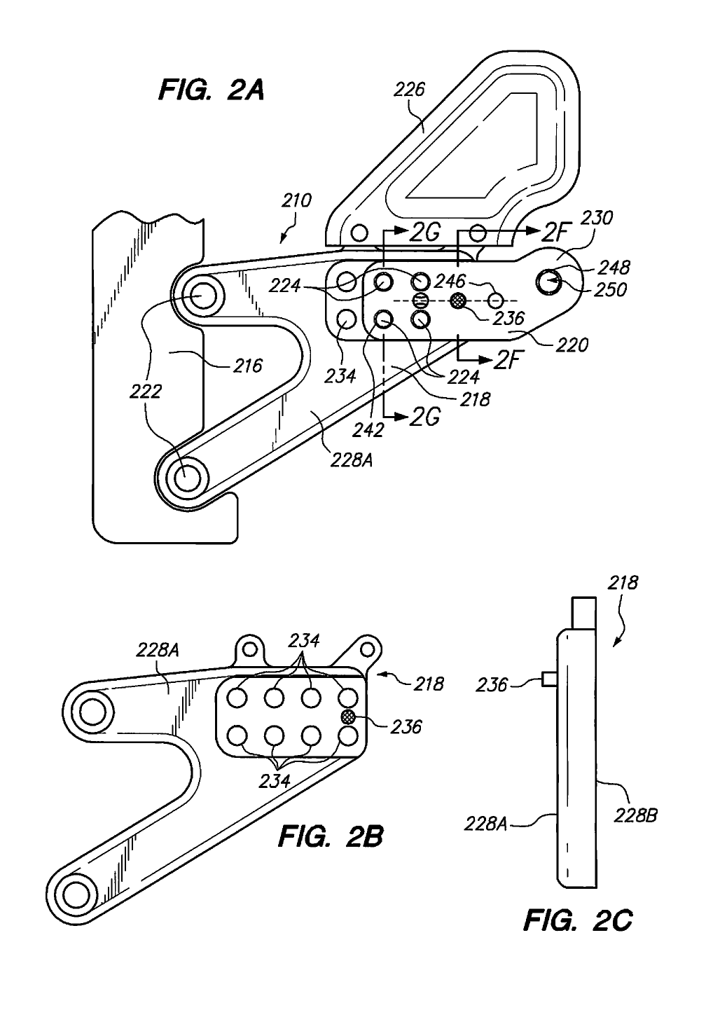

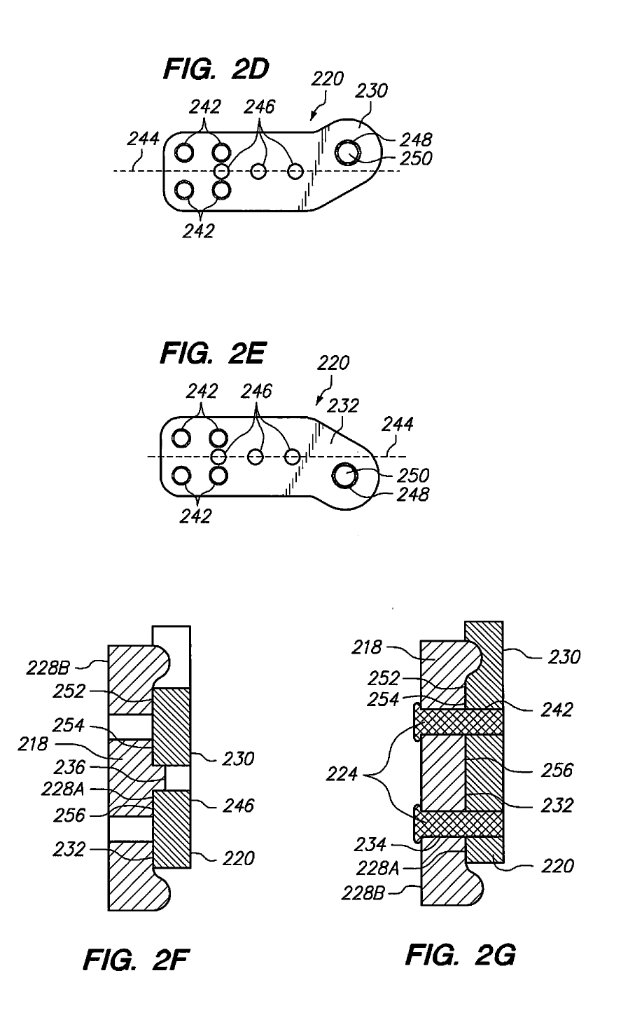

FIG. 2A is a side view of a portion of a frame 216 and one embodiment of the reversible attachment apparatus 210. In this embodiment, the attachment apparatus 210 includes a base plate 218 and a support plate 220. The design of the base plate 218 can be varied depending upon the design of the frame 216. In certain embodiments, the base plate 218 is coupled to the frame 216 of the motorcycle 2 (illustrated in FIG. 1) with one or more frame attachers 222. For example, in this embodiment, the attachment apparatus 210 includes at least two frame attachers 222. Alternatively, the attachment apparatus 210 can be designed with fewer than two frame attachers 222.

Additionally, the support plate 220 is adjustably secured to the base plate 218 with one or more plate attachers 224. For example, in this embodiment, the attachment apparatus 210 includes four plate attachers 224. However, in alternative embodiments, the attachment apparatus 210 can be designed with more than four or fewer than four plate attachers 224.

In some embodiments, as illustrated in FIG. 2A, the attachment apparatus 210 can further include a protector 226, which protects the rider from the heat of the motorcycle 2 and/or from having a portion of his or her foot or leg from getting undesirably entangled with another portion of the motorcycle 2. Alternatively, the attachment apparatus 210 can be designed without the protector 226.

In this embodiment, the base plate 218 includes a first base side 228A and an opposed second base side 228B (illustrated in FIG. 2C), wherein at least a portion of each of the base sides 228A, 228B is substantially planar. In an alternative embodiment, at least a portion of at least one of the base sides 228A, 228B can have a substantially curved surface, e.g., having convex or concave curvature. Still alternatively, at least a portion of at least one of the base sides 228A, 228B can include ridges or some other surface contour.

As illustrated in FIG. 2A, the second base side 228B can face inward toward the frame 216 and the interior of the motorcycle 2 and the first base side 228A can face away from the frame 216 and the interior of the motorcycle 2. With this orientation, the support plate 220 is adjustably secured to the first base side 228A of the base plate 218. In alternative embodiments, the base plate 218 can be reversible such that either the first base side 228A or the second base side 228B can be secured in a facing relationship with the frame 216 and the interior of the motorcycle 2. In such embodiments, the support plate 220 can be adjustably secured to either of the first base side 228A or the second base side 228B of the base plate 218.

In various embodiments, the base plate 218 can be formed from a relatively rigid and/or durable material. For example, in certain embodiments, the base plate 218 can be formed from various metals alloys, such as aluminum, titanium, stainless steel, etc. In an alternative embodiment, a composite material such as carbon fiber can be used. Alternatively, another suitably rigid material can be used to form the base plate 218. Additionally, in certain non-exclusive alternative embodiments, the base plate 218 can be manufactured through a process of molding, forging, casting, or extruding.

In this embodiment, the support plate 220 includes a first side 230 and an opposed second side 232 (illustrated in FIG. 2D), wherein at least a portion of each of the sides 230, 232 is substantially planar. In an alternative embodiment, at least a portion of each of the sides 230, 232 can have a substantially curved surface, e.g., having concave or convex curvature. Still alternatively, at least a portion of each of the sides 230, 230 can include ridges or some other surface contour. In each embodiment, each of the sides 230, 232 is designed to have a configuration that is substantially complimentary to at least one of the base sides 228A, 228B. With such design, a more secure and more compact positional relationship can be achieved between the support plate 220 and the base plate 218 when the support plate 220 is secured to the base plate 218.

For example, if the second side 232 of the support plate 220 is secured in a facing relationship in contact with the first base side 228A of the base plate 218, the second side 232 and the first base side 228A should have a substantially complimentary configuration so as to achieve a more secure and more compact positional relationship between the support plate 220 and the base plate 218. Additionally, if the second side 232 of the support plate 220 is secured in a facing relationship in contact with the second base side 228B of the base plate 218, the second side 232 and the second base side 228B should have a substantially complimentary configuration so as to achieve a more secure and more compact positional relationship between the support plate 220 and the base plate 218. Further, if the first side 230 of the support plate 220 is secured in a facing relationship in contact with the first base side 228A of the base plate 218, the first side 230 and the first base side 228A should have a substantially complimentary configuration so as to achieve a more secure and more compact positional relationship between the support plate 220 and the base plate 218. Still further, if the first side 230 of the support plate 220 is secured in a facing relationship in contact with the second base side 228B of the base plate 218, the first side 230 and the second base side 228B should have a substantially complimentary configuration so as to achieve a more secure and more compact positional relationship between the support plate 220 and the base plate 218.

As illustrated in FIG. 2A, the second side 232 can face inward toward the base plate 218 and the first side 230 can face away from the base plate 218. With this orientation, the support plate 220 is adjustably secured to the base plate 218 with the second side 232 of the support plate 220 being secured in a facing relationship in contact with the first base side 228 of the base plate 218.

In various embodiments, the support plate 220 can be formed from a relatively rigid and/or durable material. For example, in certain embodiments, the support plate 220 can be formed from various metals alloys, such as aluminum, titanium, stainless steel, etc. In an alternative embodiment, a composite material such as carbon fiber can be used. Alternatively, another suitably rigid material can be used to form the support plate 220. Additionally, in certain non-exclusive alternative embodiments, the support plate 220 can be manufactured through a process of molding, forging, casting, or extruding.

In certain embodiments, the support plate 220 is reversible such that the support plate 220 can be flipped over so that the first side 230 and/or the second side 232 can be adjustably secured in a facing relationship in contact with the base plate 218. As will be discussed in greater detail below, this enables the footpeg 14 (illustrated in FIG. 1) to have different positional relationships relative to the frame 216 depending on whether the first side 230 of the support plate 220 or the second side 232 of the support plate 220 is adjustably secured in a facing relationship in contact with the base plate 218.

FIG. 2B is a side view of one embodiment of the base plate 218 of the reversible attachment apparatus 210 illustrated in FIG. 2A. The design of the base plate 218 can be varied to suit the requirements of the attachment apparatus 210 and the vehicle to which the attachment apparatus 210 is attached. In this embodiment, the base plate 218 has a somewhat V-shaped configuration and includes the first base side 228A and the opposing second side 228B (illustrated in FIG. 2C). Alternatively, the base plate 218 can be designed to have another suitable configuration.

In some embodiments, the base plate 218 includes one or more base plate apertures 234 to enable the support plate 220 (illustrated in FIG. 2A) to be adjustably secured to the base plate 218. As illustrated in the embodiment shown in FIG. 2B, the base plate 218 can include eight spaced apart base plate apertures 234 that are arranged substantially in pairs and that are positioned near an apex of the V of the base plate 218. In alternative embodiments, the base plate 218 can include more than eight or fewer than eight base plate apertures 234, and/or the base plate apertures 234 can be arranged on the base plate 218 in different locations or with a different orientation. Still alternatively, the base plate 218 can be designed without any base plate apertures 234 and the support plate 220 can be attached to the base plate 218 by another suitable method.

As illustrated in FIG. 2B, the base plate 218 can further include one or more guide studs 236. In alternative embodiments, the guide stud(s) 236 can be manufactured separately and then fixedly secured to the base plate 218, or the guide stud(s) 236 can be integrally formed with the base plate 218 as a unitary structure and/or as a homogeneous structure. In certain embodiments, the guide stud(s) 236 can be utilized to increase the likelihood of the support plate 220 being properly and/or safely secured to the base plate 218. Stated another way, the guide stud 236 can be utilized to inhibit the support plate 220 from being improperly secured to the base plate 218, e.g., in a non-flush manner such that a less than adequate contact between the base plate 218 and the support plate 220 occurs. In this embodiment, the guide stud 236 is secured to the first base side 228 of the base plate 218 and is positioned substantially between the pair of base plate apertures 234 positioned nearest to the apex of the V of the base plate 218. Alternatively, the guide stud 236 can be in a different position on the base plate 218 relative to the base plate apertures 234. Still alternatively, the guide stud(s) 236 can be omitted from the base plate 218.

FIG. 2C is an end view of the base plate 218 illustrated in FIG. 2B. As illustrated, in this embodiment, the guide stud 236 cantilevers away from the first base side 228A of the base plate 218. The configuration of the guide stud 236 can vary. In certain alternative embodiments, the guide stud 236 can be designed to cantilever away from the second base side 228B of the base plate 218. Still alternatively, the guide stud 236 can extend fully through the remainder of the base plate 218, or separate guide studs 236 can be designed to cantilever away from each of the first base side 228A and the second base side 228B of the base plate 218.

FIG. 2D is a side view of the first side 230 of a first embodiment of the support plate 220 of the reversible attachment apparatus 210 illustrated in FIG. 2A. The design of the support plate 220 can be varied to suit the requirements of the attachment apparatus 210 and the vehicle to which the attachment apparatus 210 is attached. In this embodiment, the support plate 220 is somewhat rectangular shaped and includes a proximal end 238 that is positioned adjacent to the base plate 218 (illustrated in FIG. 2A) when the support plate 220 is secured to the base plate 218, and a distal end 240 that extends away from the base plate 218 when the support plate 220 is secured to the base plate 218. In alternative embodiments, the support plate 220 can have a different shape and/or have a different positioning relative to the base plate 218.

Additionally, in the embodiment illustrated in FIG. 2D, the support plate 220 includes one or more supporter apertures 242, one or more guide apertures 246, and a footpeg retainer 248. In this embodiment, the one or more supporter apertures 242 are positioned near the proximal end 238 of the support plate 220 to enable the support plate 220 to be adjustably secured to the base plate 218. As illustrated in the embodiment shown in FIG. 2D, the support plate 220 can include four spaced apart supporter apertures 242 that are arranged substantially in pairs and are positioned substantially symmetrically on either side of a longitudinal axis 244. Stated another way, in this embodiment, the support plate 220 includes two supporter apertures 242 that are positioned above and substantially parallel to the longitudinal axis 244, and two supporter apertures 242 that are positioned below and substantially parallel to the longitudinal axis 244. In alternative embodiments, the support plate 220 can include more than four or fewer than four supporter apertures 242, and/or the supporter apertures 242 can be arranged on the support plate 220 in different locations or with a different orientation. Still alternatively, the support plate 220 can be designed without any supporter apertures 242 and the support plate 220 can be attached to the base plate 218 by a different method.

The one or more guide apertures 246 are each adapted to alternatively receive the guide stud 236 (illustrated in FIG. 2B) when the support plate 220 is secured to the base plate 218. As illustrated in the embodiment shown in FIG. 2D, the support plate 220 can include three guide apertures 246 that are substantially equally spaced apart and aligned substantially along the longitudinal axis 244. In this embodiment, one of the guide apertures 246 is positioned substantially between two of the supporter apertures 242, and the other two guide apertures 246 are positioned away from the supporter apertures 242 toward the distal end 240 of the support plate 220. In alternative embodiments, the support plate 220 can include more than three or fewer than three guide apertures 246, and/or the guide apertures 246 can be arranged on the support plate 220 in different locations or with a different orientation depending upon the position of the guide stud(s) 236. Still alternatively, the guide apertures 246 can be omitted from the support plate 220.

The footpeg retainer 248 selectively retains the footpeg 14 (illustrated in FIG. 1) of the footpeg assembly 12 (illustrated in FIG. 1). The design and positioning of the footpeg retainer 248 can be varied to suit the requirements of the attachment apparatus 210. In the embodiment illustrated in FIG. 2D, the footpeg retainer 248 is positioned near the distal end 240 of the support plate 220, away from the supporter apertures 242 and the guide apertures 246. As illustrated, the footpeg retainer 248 is positioned in an angled region of the support plate 220 that extends from and is somewhat angled relative to the remainder of the support plate 220. In this embodiment, the angled region is angled in a generally upwardly depending direction relative to the remainder of the support plate 220 when viewing the first side 230 of the support plate 220. Alternatively, the footpeg retainer 248 can be positioned at a different location on the support plate 220. For example, the footpeg retainer 248 can be positioned closer to the supporter apertures 242 and the guide apertures 246, and/or near the proximal end 238 of the support plate 220. Still alternatively, the support plate 220 can be designed without an angled region, and the entire support plate 220 can be somewhat rectangle shaped or have another suitable shape.

Additionally, in this embodiment, the footpeg retainer 248 includes a footpeg retainer aperture 250 that is adapted to receive a portion of the footpeg 14. In this embodiment, the footpeg retainer aperture 250 is substantially circular in shape and is positioned in an offset position relative to the longitudinal axis 244. In particular, when looking at the first side 230 of the support plate 220, the footpeg retainer aperture 250 is positioned above the longitudinal axis 244. With this orientation, the footpeg 14 can be positioned in a first position relative to the frame 216 (illustrated in FIG. 2A) of the motorcycle 2 (illustrated in FIG. 1). In one embodiment, the footpeg retainer aperture 250 is positioned in a substantially aligned configuration with the two supporter apertures 242 that are positioned above and substantially parallel to the longitudinal axis 244 In alternative embodiments, the footpeg retainer aperture 250 can be positioned on the support plate 220 in different locations. For example, in some embodiments, the footpeg retainer aperture 250 can be positioned substantially along the longitudinal axis 244, and the supporter apertures 242 can be arranged and positioned such that they are not substantially symmetrically positioned on either side of the longitudinal axis 244.

Still alternatively, in certain embodiments, the footpeg retainer aperture 250 can include a slot so as to enable the footpeg 14 and the footpeg assembly 12 to be slidingly secured to the support plate 220. In such embodiments, the slot can be oriented to allow for horizontal and/or vertical adjustment of the footpeg 14 and the footpeg assembly 12 depending on the specific orientation of the slot of the footpeg retainer aperture 250 relative to the frame 216.

Yet alternatively, the footpeg retainer 248 can be designed without a footpeg retainer aperture 250, and the footpeg retainer 248 can retain the footpeg 14 by a different method.

FIG. 2E is a side view of the second side 232 of the first embodiment of the support plate 220 illustrated in FIG. 2D. In this embodiment, with the support plate 220 rotated approximately 180 degrees about the longitudinal axis 244, or “reversed”, as in FIG. 2E relative to FIG. 2D, the supporter apertures 242 are still arranged substantially in pairs. In this embodiment, each supporter aperture 242 of a given pair is positioned on opposing sides of the longitudinal axis 244 of the support plate 220. Additionally, the guide apertures 246 are still spaced apart and aligned substantially along the longitudinal axis 244 of the support plate 220. Further, in this view, when looking at the second side 232 of the support plate 220, the footpeg retainer aperture 250 is still positioned within the angled region of the support plate 220. However, the footpeg retainer aperture 250 is now positioned below the longitudinal axis 244 because the angled region is angled in a somewhat downwardly depending direction relative to the remainder of the support plate 220 when viewing the second side 232 of the support plate 220. With this orientation, the footpeg 14 can be positioned in a second position relative to the frame 216 (illustrated in FIG. 2A) of the motorcycle 2 (illustrated in FIG. 1).

As illustrated in FIGS. 2D and 2E, the support plate 220 provides an easily adjustable method for adjusting the position of the footpeg 14 relative to the frame 216 between the first position and the second position. More particularly, the support plate 220 is easily reversible such that either the first side 230 or the second side 232 can be secured in a facing relationship with and contact the base plate 218. Stated another way, when the first side 230 of the support plate 220 is secured in a facing relationship with and contacts the base plate 218, the footpeg 14 can be positioned in the first position (as illustrated in FIG. 2D), and when the second side 232 of the support plate 220 is secured in a facing relationship with and contacts the base plate 218, the footpeg 14 can be positioned in the second position (as illustrated in FIG. 2E). In this embodiment, the first position and the second position vary substantially vertically (or up and down) relative to each other. In alternative embodiments, the footpeg retainer aperture 250 can be orientated such that the first position and the second position vary substantially horizontally (or fore and aft) relative to each other. Still alternatively, the footpeg retainer aperture 250 can be orientated such that the first position and the second position vary both vertically and horizontally relative to each other. It should be noted that the use of the terms first side and second side, and first position and second position are provided merely for purposes of illustration and can be interchangeable, and no limitations are intended to the breadth and/or scope of the present invention as a result.

Referring back to FIG. 2A, the attachment of the support plate 220 to the base plate 218 is further explained. During selective alignment of the support plate 220 with the base plate 218, the four supporter apertures 242 are aligned with four of the base plate apertures 234. In this embodiment, without reversing the position of the support plate 220 so that the second side 232 is in contact with the base plate 218, the support plate 220 can be aligned in three alternative positions relative to the base plate 218. For example, the four supporter apertures 242 can be aligned with the four base plate apertures 234 that are farthest away from the apex of the V of the base plate 218; the four supporter apertures 242 can be aligned with the middle four base plate apertures 234; or the four supporter apertures 242 can be aligned with the four base plate apertures 234 that are nearest to the apex of the V of the base plate 218. Once the supporter apertures 242 are properly aligned with the selected base plate apertures 234, the plate attachers 224 can be positioned within and extend through the supporter apertures 242 and the corresponding base plate apertures 234. In different embodiments, the plate attachers 224 can threadedly engage the supporter apertures 242 and the base plate apertures 234, and/or the plate attachers 224 can secure the support plate 220 to the base plate 218 via the supporter apertures 242 and the base plate apertures 234 by a different means.

Additionally, in this embodiment, the attachment apparatus 210 is designed so that the support plate 220 can not be adequately secured to the base plate 218 unless the guide stud 236 is positioned within one of the guide apertures 246. Accordingly, as noted above, the support plate 220 can only be adequately secured to the base plate 218 when the four supporter apertures 242 are positioned to correspond with four of the base plate apertures 234. For example, when the four supporter apertures 242 are aligned with the four base plate apertures 234 that are farthest away from the apex of the V of the base plate 218, the guide stud 236 will fit within the guide aperture 246 that is positioned nearest the proximal end 238 of the support plate 220 and substantially between two of the supporter apertures 242. Additionally, when the four supporter apertures 242 are aligned with the middle four base plate apertures 234, the guide stud 236 will fit within the middle guide aperture 246. Further, when the four supporter apertures 242 are aligned with the four base plate apertures 234 that are nearest to the apex of the V of the base plate 218, the guide stud 236 will fit within the guide aperture 246 that is positioned nearest to the distal end 240 of the support plate 220. At this point, the plate attachers 224 will fit securely within and extend through the supporter apertures 242 and the base plate apertures 234. Stated another way, the guide apertures 246 are positioned so that unless the guide stud 236 is received by one of the guide apertures 246, the plate attachers 224 will not extend through at least one of the supporter apertures 242 and the base plate apertures 234. With this design, the structural integrity and robustness of the attachment apparatus 210 is enhanced.

FIG. 2F is a cross-sectional view of the base plate 218 and the support plate 220 taken on line 2F-2F in FIG. 2A. In this embodiment, the base plate 218 includes the first base side 228A and the second base side 228B, wherein the first base side 228A includes a recessed section 252, a base plate contact surface 254 that is positioned substantially within the recessed section 252, and the guide stud 236 that cantilevers away from the base plate contact surface 254. The recessed section 252 is adapted to receive at least a portion of the support plate 220 when the support plate 220 is being secured to the base plate 218. Additionally, the recessed section 252 also allows the support plate 220 to be “inset” relative to the base plate 218 so as to reduce the overall width of the motorcycle 2 (illustrated in FIG. 1) so the footpeg (illustrated in FIG. 1) does not stick out too far laterally.

In some embodiments, the second base side 228B can additionally or alternatively include a guide stud, a recessed section and/or a base plate contact surface. It should be noted that the reference to the base plate contact surface 254 is merely a reference to the surface of the base plate 218 that contacts the support plate 220 when the support plate 220 is secured to the base plate 218.

In the embodiment illustrated in FIG. 2F, the base plate contact surface 254 is substantially planar. In one embodiment, the base plate contact surface 254 is substantially planar except for the contour of the guide stud 236 that cantilevers away from the base plate contact surface 254. In an alternative embodiment, the base plate contact surface 254 can have a substantially curved surface, e.g., having convex or concave curvature. Still alternatively, the base plate contact surface 254 can include ridges or some other surface contour.

As illustrated in FIG. 2F, the support plate 220 includes the first side 230 and the second side 232. In the orientation illustrated in FIG. 2F, with the first side 230 of the support plate 220 facing away from the base plate 218 and the second side 232 of the support plate 220 facing toward the base plate, the second side 232 includes a support plate contact surface 256. When the orientation of the support plate 220 is reversed such that the first side 230 of the support plate 220 is facing the base plate 218, the first side 230 includes the support plate contact surface 256. It should be noted that the reference to the support plate contact surface 256 is merely a reference to the surface of the support plate 220 that contacts the base plate 218 when the support plate 220 is secured to the base plate 218.

In this embodiment, the support plate contact surface 256 is substantially planar. In an alternative embodiment, the support plate contact surface 256 can have a substantially curved surface, e.g., having convex or concave curvature. Still alternatively, the support plate contact surface 256 can include ridges or some other surface contour. In each embodiment, the support plate contact surface 256 is designed to have a configuration that is substantially complimentary to the base plate contact surface 254. With such design, a more secure and more compact positional relationship can be achieved between the support plate 220 and the base plate 218 when the support plate 220 is secured to the base plate 218.

Additionally, in FIG. 2F, one of the guide apertures 246 is visible within the support plate 220. The guide aperture 246 is adapted to receive the guide stud 236 when the support plate 220 is secured to the base plate 218. As noted above, the positioning of the guide stud 236 within one of the guide apertures 246 increases the likelihood that the support plate 220 can be adequately secured to the base plate 218.

FIG. 2G is a cross-sectional view of the base plate 218, the support plate 220, and a pair of plate attachers 224 taken on line 2G-2G in FIG. 2A. As illustrated in FIG. 2G, the base plate 218 includes the first base side 228A having the recessed section 252 and the base plate contact surface 254 that is positioned substantially within the recessed section 252. Additionally, the base plate 218 further includes a pair of base plate apertures 234 that are positioned within the recessed section 252 and which extend fully through the base plate 218 from the first base side 228A to the second base side 228B.

Additionally, visible in this view, the support plate 220 includes the first side 230, the second side 232 having the support plate contact surface 256, and a pair of supporter apertures 242 which extend fully through the support plate 220 from the first side 230 to the second side 232.

In this embodiment, the plate attachers 224 extend fully through the base plate apertures 234 and the supporter apertures 242 to secure the support plate 220 to the base plate 218.

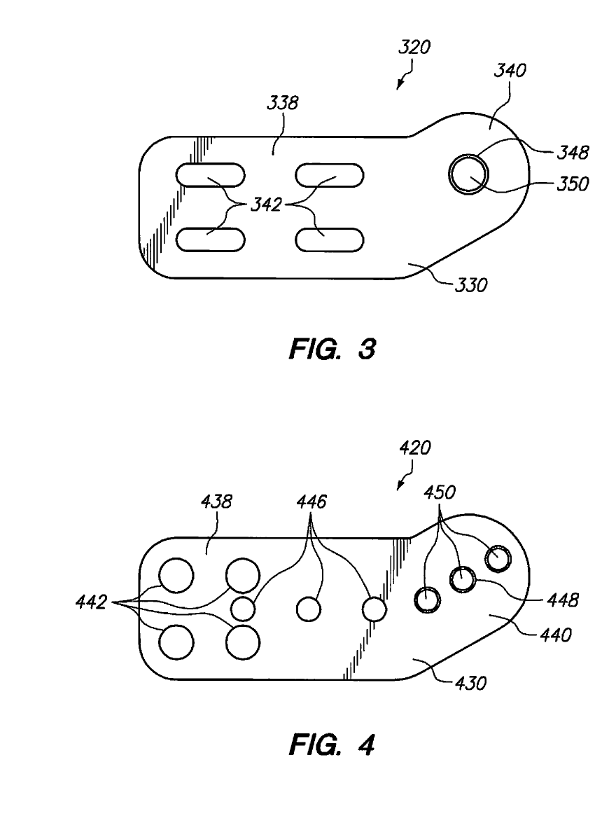

FIG. 3 is a side view of another embodiment of a support plate 320 of the reversible attachment apparatus 210 (illustrated in FIG. 2A). Many of the features of the support plate 320 are substantially similar to the features as described and illustrated above in relation to FIG. 2D. For example, in this embodiment, the support plate 320 is again somewhat rectangular shaped and includes a first side 330, an opposed second side (not illustrated), a proximal end 338 that is positioned adjacent to the base plate 218 (illustrated in FIG. 2A) when the support plate 320 is secured to the base plate 218, and a distal end 340 that extends away from the base plate 218 when the support plate 220 is secured to the base plate 218.

The support plate 320 further includes a footpeg retainer 348 having a footpeg retainer aperture 350, which is substantially similar in design and positioning to the footpeg retainer aperture 250 as illustrated and described above in relation to FIG. 2D. The footpeg retainer aperture 350 is adapted to receive a portion of the footpeg 14 (illustrated in FIG. 1) of the footpeg assembly 12 (illustrated in FIG. 1). With this design, the footpeg 14 can be positioned in a first position relative to the frame 216 (illustrated in FIG. 2A) of the motorcycle 2 (illustrated in FIG. 1) when the first side 330 is visible and the footpeg 14 can be positioned in a second position relative to the frame 216 when the second side is visible.

In this embodiment, the support plate 320 again includes one or more supporter apertures 342. However, in this embodiment, each of the supporter apertures 342 includes a slot so as to enable the support plate 320 to be slidably secured to the base plate 218 (illustrated in FIG. 2A). In some embodiments, the length of the slot can be approximately the same as the horizontal distance between adjacent supporter apertures 342 or slots. With this design, the support plate 320 can be adjusted relative to the base plate 218 substantially along a continuum.

FIG. 4 is a side view of yet another embodiment of a support plate 420 of the reversible attachment apparatus 210 (illustrated in FIG. 2A). Many of the features of the support plate 420 are substantially similar to the features as described and illustrated above in relation to FIG. 2D. For example, in this embodiment, the support plate 420 is again somewhat rectangular shaped and includes a first side 430, a second side (not illustrated) that is opposite the first side 430, a proximal end 438, a distal end 440, one or more supporter apertures 442 and one or more guide apertures 446, which are substantially similar to the corresponding features as illustrated and described above in relation to FIG. 2D.

Additionally, in this embodiment, the support plate 420 again includes a footpeg retainer 448 that is positioned in an angled region of the support plate 420 near the distal end 440 of the support plate 420. However, as illustrated in FIG. 4, the angled region of the support plate 420 is somewhat larger than in the previous embodiments. The angled region still extends away from and is somewhat angled relative to the remainder of the support plate 420, but the angled region extends somewhat farther away from the remainder of the support plate 420 than in the previous embodiments. Further, as illustrated, the footpeg retainer 448 includes three footpeg retainer apertures 450, which are each adapted to alternatively receive a portion of the footpeg 14 (illustrated in FIG. 1). This enables the user to have even further potential positions for the footpeg 14 so as to enhance the comfort level of the user. In alternative embodiments, the footpeg retainer 448 can include more than three or less than three footpeg retainer apertures 450.

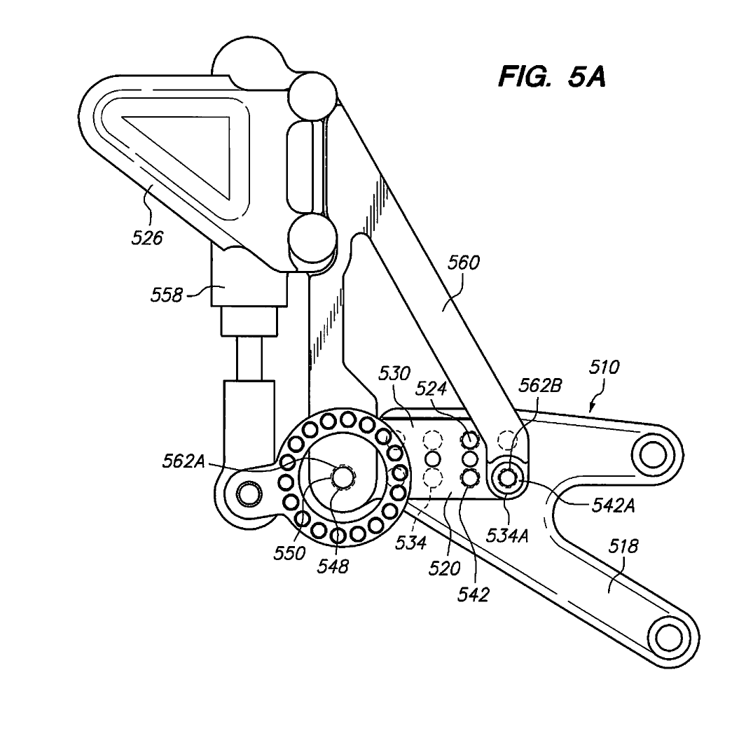

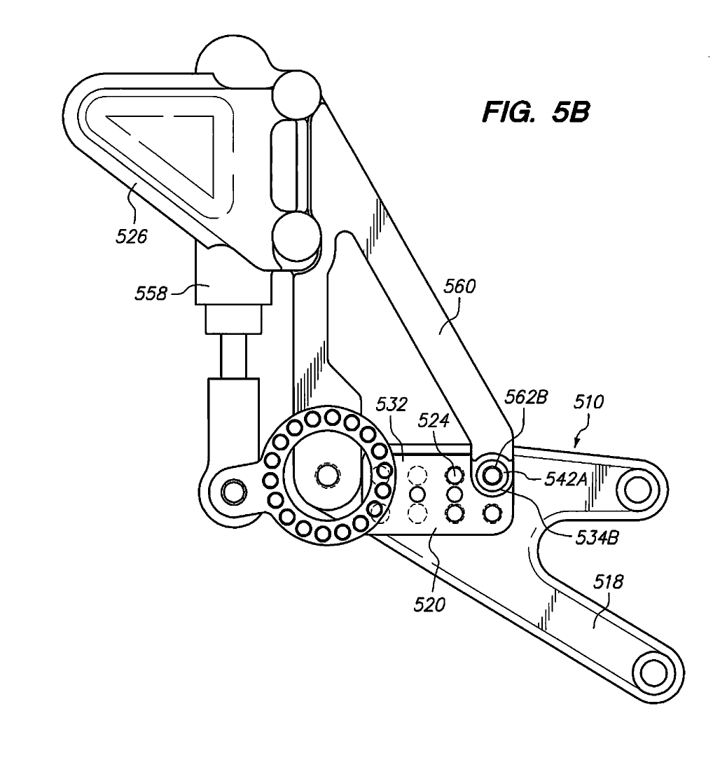

FIG. 5A is a side view of a portion of the motorcycle 2 (illustrated in FIG. 1) and another embodiment of a reversible attachment apparatus 510 having features of the present invention. In particular, FIG. 5A illustrates a portion of a master cylinder 558, a protector 526, a protector attacher 560, and the attachment apparatus 510. This embodiment of the attachment apparatus 510 has various substantially similar features as the embodiment of the attachment apparatus 210 illustrated and described above in relation to FIG. 2A. For example, the base plate 518 and the support plate 520 are substantially similar to the base plate 218 and the support plate 220 as described in relation to FIG. 2A. Accordingly, a detailed description of the base plate 518 and the support plate 520 will not be repeated. However, in this embodiment, the attachment apparatus 510 is coupled to and/or protects at least a portion of the master cylinder 558. Additionally, in this embodiment, the protector attacher 560 couples the attachment apparatus 510 to the protector 526.

Similar to the embodiment illustrated in FIG. 2D, in this embodiment, the base plate 518 includes one or more base plate apertures 534 and the support plate includes one or more supporter apertures 542. Further, in this embodiment, the attachment apparatus 510 includes one or more plate attachers 524 that can be positioned within and extend through the supporter apertures 542 and the corresponding base plate apertures 534 to adjustably secure the support plate 520 to the base plate 518.

Additionally, in this embodiment, the support plate 520 again includes a footpeg retainer 548 having a footpeg retainer aperture 550 that is positioned in a substantially aligned configuration with two of the supporter apertures 542.

As provided above, the protector attacher 560 couples the attachment apparatus 510 to the protector 526. The design of the protector attacher 560 can be varied to suit the requirements of the attachment apparatus 510 and the motorcycle 2 to which the attachment apparatus 510 is attached. In this embodiment, the protector attacher 560 includes a first attacher aperture 562A and a second attacher aperture 562B. Alternatively, the protector attacher 560 can be designed with more than two or fewer than two attacher apertures 562A, 562B.

In this embodiment, the first attacher aperture 562A is designed and positioned to be substantially aligned with the footpeg retainer aperture 548 and is adapted to receive a portion of the footpeg 14 (illustrated in FIG. 1).

As illustrated in FIG. 5A, the second attacher aperture 562B can be designed and positioned to be substantially aligned with one of the supporter apertures 542 and one of the base plate apertures 534. Further, one of the plate attachers 524 is positioned within and extends through one of the supporter apertures 542, one of the base plate apertures 534, and the second attacher aperture 562B. In particular, when the first side 530 of the support plate 520 is facing away from the base plate 518, one of the plate attachers 524 is positioned within and extends through a first supporter aperture 542A, a first base plate aperture 534A, and the second attacher aperture 562B. With this design, the plate attachers 524 simultaneously secure the support plate 520 to the base plate 518, and secure the attachment apparatus 510 to the protector attacher 560, which, in turn, couples the attachment apparatus 510 to the protector 526 and the master cylinder 558.

FIG. 5B is a side view of the portion of the motorcycle 2 (illustrated in FIG. 1) and the reversible attachment apparatus 510 in FIG. 5A, with the support plate 520 having been reversed. In particular, FIG. 5A illustrates the support plate 520 with the second side 532 of the support plate 520 facing away from the base plate 518. In this configuration, one of the plate attachers 524 is positioned within and extends through the first supporter aperture 542A, a second base plate aperture 534B, and the second attacher aperture 562B. With this design, the plate attachers 524 again simultaneously secure the support plate 520 to the base plate 518, and secure the attachment apparatus 510 to the protector attacher 560, which, in turn, couples the attachment apparatus 510 to the protector 526 and the master cylinder 558.

Additionally, when the support plate 520 is reversed from having the first side 530 facing away from the base plate 518, as illustrated in FIG. 5A, to having the second side 532 facing away from the base plate 518, as illustrated in FIG. 5B, the protector attacher 560, the protector 526 and the master cylinder 558 all move together as a unit relative to the base plate 518.

While a number of exemplary aspects and embodiments of a reversible attachment apparatus 10 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. An attachment apparatus for adjusting the position of a footpeg of a motorcycle relative to a frame of the motorcycle, the attachment apparatus comprising:
a base plate that is coupled to the frame; and
a support plate that is secured to the base plate, the support plate having (i) a first side, (ii) a second side that is opposite the first side, and (iii) a footpeg retainer that retains the footpeg, the support plate selectively supporting the footpeg in a first position while the first side contacts the base plate and a second position while the second side contacts the base plate, the second position being different relative to the frame than the first position.

2. The attachment apparatus of claim 1 wherein at least a portion of the first side is substantially planar.

3. The attachment apparatus of claim 2 wherein at least a portion of the second side is substantially planar.

4. The attachment apparatus of claim 1 further comprising a plate attacher, the support plate including a supporter aperture and the base plate including a base plate aperture, the plate attacher extending through the supporter aperture and the base plate aperture to secure the support plate to the base plate.

5. The attachment apparatus of claim 4 wherein the supporter aperture includes a slot so that the support plate is slidably secured to the base plate.

6. The attachment apparatus of claim 4 wherein the base plate includes a guide stud, and the support plate includes a guide aperture that is adapted to receive the guide stud to inhibit the support plate from being improperly secured to the base plate.

7. The attachment apparatus of claim 6 wherein the guide aperture is positioned so that unless the guide stud is received by the guide aperture, the plate attacher will not extend through at least one of the supporter aperture and the base plate aperture.

8. The attachment apparatus of claim 1 wherein the attachment apparatus includes a pair of plate attachers that secure the support plate to the base plate.

9. The attachment apparatus of claim 8 wherein the support plate includes a plurality of pairs of supporter apertures and the base plate includes a plurality of pairs of base plate apertures, the pair of plate attachers extending through one pair of supporter apertures and one pair of base plate apertures to secure the support plate to the base plate.

10. The attachment apparatus of claim 1 wherein the attachment apparatus includes two pairs of plate attachers that secure the support plate to the base plate.

11. The attachment apparatus of claim 10 wherein the support plate includes a plurality of pairs of supporter apertures and the base plate includes a plurality of pairs of base plate apertures, the two pairs of plate attachers extending through two pairs of supporter apertures and two pairs of base plate apertures to secure the support plate to the base plate.

12. The attachment apparatus of claim 1 wherein the footpeg retainer includes a plurality of footpeg retainer apertures, each footpeg retainer aperture being adapted to receive a portion of the footpeg.

13. The attachment apparatus of claim 1 wherein the support plate includes a longitudinal axis, and wherein the footpeg retainer is offset from the longitudinal axis.

14. The attachment apparatus of claim 1 wherein the base plate includes a base plate contact surface and the support plate includes a support plate contact surface that directly contacts the base plate contact surface when the support plate is secured to the base plate, the base plate contact surface and the support plate contact surface being substantially complimentary to one another.

15. A motorcycle including a master cylinder, a protector, a protector attacher and the attachment apparatus of claim 1, the protector attacher coupling the attachment apparatus to the protector and the master cylinder, wherein when the support plate is moved from having the first side contact the base plate to having the second side contact the base plate, the master cylinder, the protector and the protector attacher all move together as a unit relative to the base plate.

16. A method for adjusting the position of a footpeg of a motorcycle relative to a frame of the motorcycle, the method comprising the steps of:
coupling a base plate to the frame; and
securing a support plate to a first base side of the base plate, the support plate having (i) a first side, (ii) a second side that is opposite the first side, and (iii) a footpeg retainer that selectively retains the footpeg in a first position and a second position relative to the frame, the position of the footpeg being based on whether the first side or the second side of the support plate is secured to the first base side of the base plate.

17. The method of claim 16 wherein the step of securing the support plate includes the step of securing the support plate to the base plate with a plate attacher.

18. The method of claim 17 wherein the step of securing the support plate includes the support plate having a supporter aperture and the base plate having a base plate aperture, and the plate attacher extending through the supporter aperture and the base plate aperture to secure the support plate to the base plate.

19. The method of claim 16 wherein the step of securing the support plate includes the support plate having a guide aperture and the base plate having a guide stud, and positioning the guide stud into the guide aperture to inhibit the support plate from being improperly secured to the base plate.

20. The method of claim 16 wherein the step of securing the support plate includes the footpeg retainer having a plurality of footpeg retainer apertures, each footpeg retainer being adapted to receive a portion of the footpeg.

21. The method of claim 16 wherein the step of securing the support plate includes positioning the footpeg retainer offset a longitudinal axis of the support plate.

22. The method of claim 16 wherein the step of securing the support plate includes directly contacting a base plate contact surface with a support plate contact surface when the support plate is secured to the base plate, the base plate contact surface having a substantially complimentary configuration to the support plate contact surface.

23. An attachment apparatus for adjusting the position of a footpeg of a motorcycle relative to a frame of the motorcycle, the attachment apparatus comprising:
a base plate that is coupled to the frame, the base plate including a plurality of pairs of base plate apertures and a guide stud;
a support plate that is secured to the base plate, the support plate having (i) a first side, (ii) a second side that is opposite the first side, (iii) a plurality of pairs of supporter apertures, (iv) a guide aperture, (v) a longitudinal axis, and (vi) a footpeg retainer that retains the footpeg, the footpeg retainer being offset from the longitudinal axis, the support plate selectively supporting the footpeg in a first position while the first side contacts the base plate and a second position while the second side contacts the base plate, the second position being different relative to the frame than the first position; and
two pairs of plate attachers that extend through two pairs of supporter apertures and two pairs of base plate apertures to secure the support plate to the base plate, wherein the guide aperture is adapted to receive the guide stud to inhibit the support plate from being improperly secured to the base plate.
